(19) United States
(12) Patent Application Publication
(10) Pub. No.: US 2015/0002426 A1
(43) Pub. Date: Jan. 1, 2015

(54) MOBILE DEVICE AND METHOD FOR MANAGING INPUT SIGNALS OF DISPLAY DEVICE

(71) Applicant: HON HAI PRECISION INDUSTRY CO., LTD., New Taipei (TW)

(72) Inventors: MING-CHUAN KAO, New Taipei (TW); CHENG-JUI YU, New Taipei (TW)

(21) Appl. No.: 14/315,782

(22) Filed: Jun. 26, 2014

(30) Foreign Application Priority Data
Jun. 28, 2013 (CN) 2013102678240

(51) Int. Cl. G06F 3/041

(52) U.S. Cl. CPC G06F 3/041
USPC 345/173

(57) ABSTRACT

Method of managing input signals of a first display device includes determining a specified electronic device to be an input signal source of the first display device, and displaying a specified virtual remote controller of the specified electronic device on a second display device of a mobile device. In response to detecting touch signals on the second display device, a virtual remote controller is determined. When the determined virtual remote controller is different from the specified virtual remote controller, a first switch signal corresponding to the specified virtual remote controller is sent, and the input signal source is controlled to switch from the specified electronic device to a default electronic device. A second switch signal corresponding to the determined virtual remote controller is sent. The input signal source is controlled to switch from the default electronic device to an electronic device corresponding to the determined virtual remote controller.

### FIELD

Embodiments of the present disclosure relate to display controlling technology, and particularly to a mobile device and a method for managing input signals of a display device using the mobile device.

### BACKGROUND

A display device may be connected to a plurality of electronic devices. Each of the electronic devices can be an input signal source of the display device. A user needs to switch between the electronic devices to determine a desired input signal source for the display device by hand.

### BRIEF DESCRIPTION OF THE DRAWINGS

Implementations of the present technology will now be described, by way of example only, with reference to the attached figures.

FIG. 1 illustrates a diagrammatic view of one embodiment of a mobile device including a management system.

FIG. 2 illustrates a block diagram of one embodiment of function modules of the management system in the mobile device of FIG. 1.

FIG. 3 illustrates a flowchart of one embodiment of a method for managing input signals.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

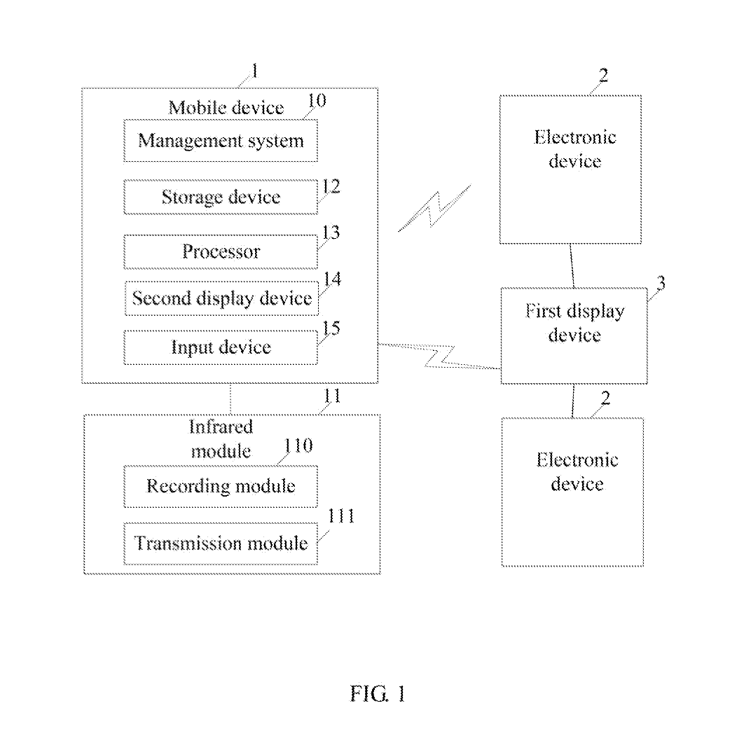

FIG. 1 illustrates a diagrammatic view of one embodiment of an application environment of a mobile device 1 including a management system 10. The mobile device 1 is connected to a plurality of electronic devices 2. The electronic devices 2 can be a television, a Digital Versatile Disc (DVD) device, or other suitable devices. The electronic devices 2 can be connected to a first display device 3. Each of the electronic devices 2 can be an input signal source of the first display device 3, to transmit different kinds of signals to the first display device 3.

The mobile device 1 can be connected to an infrared module 11. In other embodiments, the infrared module 11 can be included in the mobile device 1. The infrared module 11 can include, but is not limited to, a recording module 110 and a transmission module 111. The mobile device 1 can further include a storage device 12, at least one processor 13, a second display device 14, and an input device 15. The mobile device 1 can be a tablet computer, a smart phone, a personal digital assistant (PDA), or other suitable mobile device. It should be understood that FIG. 1 illustrates only one example of the mobile device that can include more or fewer components than illustrated, or have a different configuration of the various components in other embodiments.

The management system 10 can automatically switch among a plurality of input signal sources of the first display device 3 according to a user selection.

In at least one embodiment, the storage device 12 can include various types of non-transitory computer-readable storage medium, such as a hard disk, a compact disc, a digital video disc, or a tape drive. The second display device 14 can display images and videos. The input device 15 can be a mouse, a keyboard, a touch panel, or other suitable input device to input computer-readable data.

In at least one embodiment, each of the electronic devices 2 corresponds to a virtual remote controller, which can be displayed on the second display device 14 to be selected by a user.

In at least one embodiment, each of the electronic devices 2 can be classified into any of a plurality of signal source groups. Each of the signal source groups can include a plurality of electronic devices 2, and one of the electronic devices 2 of each signal source group is preset as a predetermined electronic device. Each of the signal source groups corresponds to a group number. The signal source groups and corresponding group numbers are stored in the storage device 12. In the embodiment, one of the stored signal source groups can be a default signal source group, and the virtual remote controller of the predetermined electronic device of the default signal source group is displayed on the second display device 14.

The default signal source group and the other signal source groups can be displayed together on the second display device 14. A user can switch the default signal source group to be one of the other signal source groups by a touch operation (e.g., a press operation or a slide operation) on the second display device 14. When one of the signal source groups among the other signal source groups is selected by the user, a group number of the selected signal source group is determined. Thus, the selected signal source group can be determined to be an updated default signal source group.

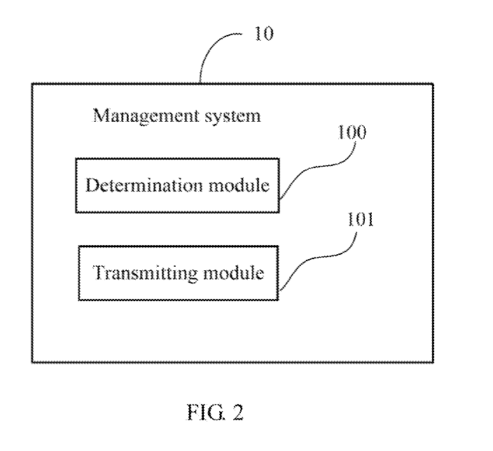

FIG. 2 illustrates a block diagram of one embodiment of function modules of the management system 10. In at least one embodiment, the management system 10 can include a determination module 100 and a transmission module 101. The modules 100 and 101 can include computerized codes in the form of one or more programs, which are stored in the storage device 12. The at least one processor 13 executes the computerized codes to provide functions of the function modules 100 and 101.

The determination module 100 determines a specified electronic device to be an input signal source of the first display device 3, and displays a specified virtual remote controller of the specified electronic device on the second display device 14. In one embodiment, the specified electronic device can be determined to be the predetermined electronic device of the default signal source group, and the specified virtual remote controller is the virtual remote controller corresponds to the specified electronic device. Thus, a user can execute touch operations on the second display device 14 to control the specified virtual remote controller to control the specified electronic device.

In detail, when the management system 10 is executed, the determination module 100 reads the group number of the default signal source group from the storage device 12, and displays the default signal source group including one or more electronic devices 2 on the second display device 14. The determination module 100 can determine the predetermined electronic device of the default signal source group to be the specified electronic device. Then, the specified virtual remote controller of the specified electronic device is displayed on the second display device 14.

When the specified virtual remote controller is displayed on the second display device 14, the user can select another virtual remote controller, either from the default signal source group or from any of the other signal source groups, by executing one or more touch operations (e.g., a press operation or a slide operation) on the second display device 14. In response to detecting one or more touch operations on the second display device 14, the determination module 100 determines a virtual remote controller.

In one embodiment, when the user executes one or more touch operations on the display device 14, one or more touch signals are detected. The touch signals can be press signals of the press operations, or slide signals of the slide operations. In response to detecting the touch signals (e.g., the press signals or the slide signals) on the second display device 14, the determination module 100 determines the selected virtual remote controller. The selected virtual remote controller is displayed on the second display device 14. The determination module 100 calculates a display time duration of the selected virtual remote controller on the second display device 14. When the display time duration is not less than a predetermined display time duration, the determination module 100 determines the selected virtual remote controller to be a determined virtual remote controller.

The determination module 100 determines whether the determined virtual remote controller is different from the specified virtual remote controller. In at least one embodiment, each virtual remote controller corresponds to an identification number, and the determination module 100 compares an identification number of the determined virtual remote controller to an identification number of the specified virtual remote controller. When the identification number of the determined virtual remote controller is different from the identification number of the specified virtual remote controller, the determination module 100 determines that the determined virtual remote controller is different from the specified virtual remote controller. When the determined virtual remote controller is the same as the specified virtual remote controller, the specified virtual remote controller continues being displayed on the second display device 14.

When the determined virtual remote controller is different from the specified virtual remote controller, the transmitting module 101 transmits a first switch signal corresponding to the specified virtual remote controller to the first display device 3, and controls the input signal source to switch from the specified electronic device to a default electronic device. In at least one embodiment, the default electronic device can be a predetermined electronic device of one of the signal source groups.

The transmitting module 101 transmits a second switch signal corresponding to the determined virtual remote controller to the first display device 3, and controls the input signal source to switch from the default electronic device to the electronic device 2 corresponding to the determined virtual remote controller.

In at least one embodiment, the first switch signal and the second switch signal are recorded by the infrared module 11, and stored in the storage device 12. In the embodiment, the infrared module 11 records input signals from a physical remote controller (not shown). The physical remote controller can include a plurality of keys.

For example, a specified electronic device corresponding to a specified virtual remote controller is represented as “Cable1”. An electronic device corresponding to a determined virtual remote controller is represented as “HDM1”. A default electronic device is represented as “Cable2”. When keys “[input],” “[down],” “[down],” and “[ok]” of the remote controller are pressed by a user in sequence, a first switch signal corresponding to the specified virtual remote controller is recorded. When keys “[input],” “[up],” “[up],” and “[ok]” of the remote controller are pressed by the user in sequence, a second switch signal corresponding to the determined virtual remote controller is recorded. When the first switch signal is transmitted to the first display device 3, the input signal source of the first display device 3 is switched from “Cable1” to “Cable2.” When the second signal is transmitted to the first display device 3, the input signal source of the first display device 3 is switched from “Cable2” to “HDM1.” Thus, the input signal source of the first display device 3 can be switched conveniently.

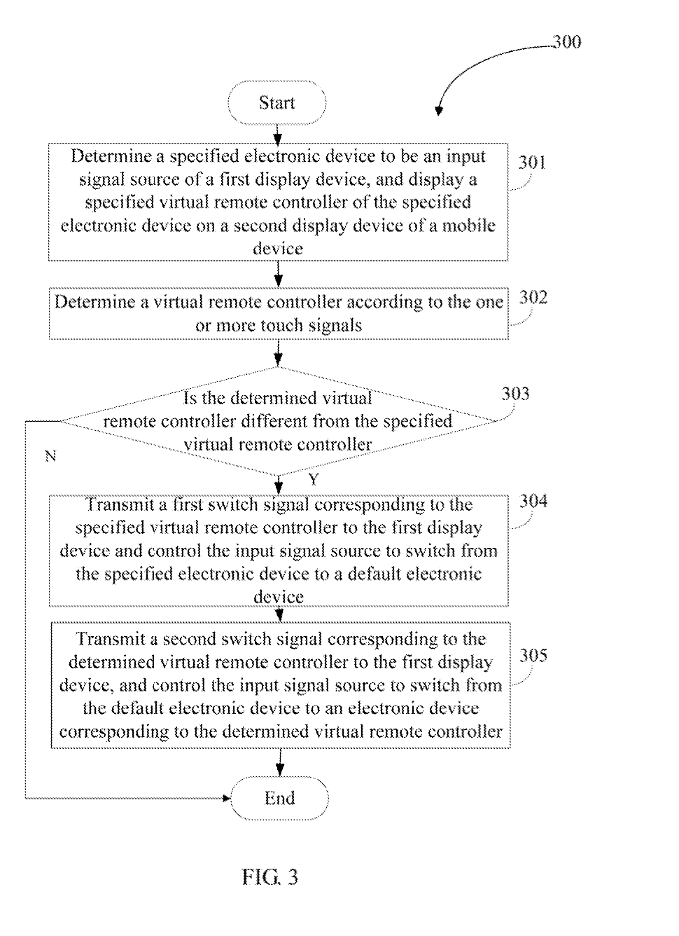

FIG. 3 illustrates a flowchart of an example embodiment of a method managing input signals using a mobile device. The method is provided by way of example, as there are a variety of ways to carry out the method. The method described below can be carried out using the configurations illustrated in FIGS. 1, 2, for example, and various elements of FIGS. 1, 2 are referenced in explaining the method. Each block shown in FIG. 3 represents one or more processes, methods, or subroutines carried out in the method. Additionally, the illustrated order of blocks is by example only, and the order of the blocks can change according to the present disclosure. The exemplary method can begin at block 301. Depending on the embodiment, additional steps can be added, others removed, and the ordering of the steps can be changed.

In block 301, a determination module determines a specified electronic device to be an input signal source of a first display device, and displays a specified virtual remote controller of the specified electronic device on a second display device of a mobile device. The mobile device is connected to a plurality of electronic devices. The electronic devices can be a television, a Digital Versatile Disc (DVD) device, or other suitable devices. The electronic devices can be connected to the first display device. Each of the electronic devices can be an input signal source of the first display device, to transmit different kinds of signals to the first display device.

In at least one embodiment, each of the electronic devices corresponds to a virtual remote controller, which can be displayed on the second display device to be selected by a user.

In at least one embodiment, each of the signal source groups can include a plurality of electronic devices, and one of the electronic devices of each signal source group is preset as a predetermined electronic device. Each of the signal source groups corresponds to a group number. The signal source groups and corresponding group numbers are stored in a storage device of the mobile device. In the embodiment, one of the stored signal source groups can be a default signal source group, and the virtual remote controller of the predetermined electronic device of the default signal source group is displayed on the second display device.

The default signal source group and the other signal source groups can be displayed together on the second display device. A user can switch the default source group to be one of the other signal source groups by touch operation (e.g., a press operation or a slide operation)on the second display device. When one of the signal source groups among the other signal source groups is selected by the user, a group number of the selected signal source group is determined. The selected signal source group is determined to be an updated default signal source group.

When a management system (for example, a management system 10 as shown in FIG. 1) is executed, the determination module reads a group number of the default signal source group from the storage device, and displays the default signal source group including one or more electronic devices (for example, the electronic device 2 as shown in FIG. 1) on the second display device. The determination module can determine a predetermined electronic device in the default signal source group to be the specified electronic device. Then a specified virtual remote controller of the specified electronic device is displayed on the second display device.

In block 302, when the specified virtual remote controller is displayed on the second display device, the user can select another virtual remote controller, either from the default signal source group or from any of the other signal source groups, by executing one or more touch operations (e.g., a press operation or a slide operation) on the second display device. In response to detecting one or more touch operations on the second display device, the determination module determines a virtual remote controller according to detecting touch signals on the second display device.

In one embodiment, when the user executes one or more touch operations, one or more touch signals are detected. The touch signal can be press signals of the press operations or slide signals of the slide operations. In response to detecting the touch signals (e.g., the press signals or the slide signals) on the second display device, the determination module determines a selected virtual remote controller. The selected virtual remote controller is displaying on the second display device. The determination module calculates a display time duration of the selected virtual remote controller that displayed on the second display device. When the display time duration is not less than a predetermined duration, the determination module determines the selected virtual remote controller to be a determined virtual remote controller.

In block 303, the determination module determines whether the determined virtual remote controller is different from the specified virtual remote controller. In at least one embodiment, each virtual remote controller corresponds to an identification number, and the determination module compares an identification number of the determined virtual remote controller and an identification number of the specified virtual remote controller. When the identification number of the determined virtual remote controller is different from the identification number of the specified virtual remote controller, the determination module determines that the determined virtual remote controller is different from the specified virtual remote controller. When the determined virtual remote controller is the same as the specified virtual remote controller, no more switch is needed.

In block 304, when the determined virtual remote controller is different from the specified virtual remote controller, a transmitting module transmits a first switch signal corresponding to the specified virtual remote controller to the first display device, and controls the input signal source to switch from the specified electronic device to a default electronic device. In at least one embodiment, the default electronic device can be a predetermined electronic device of one of the signal source groups.

In block 305, the transmitting module transmits a second switch signal corresponding to the determined virtual remote controller to the first display device, and controls the input signal source to switch from the default electronic device to an electronic device corresponding to the determined virtual remote controller.

In at least one embodiment, the first switch signal and the second switch signal are recorded by a infrared module which is connected to the mobile device, and stored in the storage device. In the embodiment, the infrared module records input signals from a physical remote controller. The physical remote controller can include a plurality of keys.

For example, a specified electronic device corresponding to a specified virtual remote controller is represented as “Cable1”. An electronic device corresponding to a determined virtual remote controller is represented as “HDM1”. A default electronic device is represented as “Cable2”. When keys “[input],” “[down],” “[down],” and “[ok]” of the remote controller are pressed by a user in sequence, a first switch signal corresponding to the specified virtual remote controller is recorded. When keys “[input],” “[up],” “[up],” and “[ok]” of the remote controller are pressed by the user in sequence, a second switch signal corresponding to the determined virtual remote controller is recorded. When the first switch signal is transmitted to the first display device, the input signal source of the first display device is switched from “Cable1” to “Cable2.” When the second signal is transmitted to the first display device, the input signal source of the first display device is switched from “Cable2” to “HDM1.” Thus, the input signal source of the first display device can be switched conveniently.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for managing input signals of a first display device using a mobile device, the mobile device being in connection to electronic devices, each of the electronic devices corresponding to a virtual remote controller, the method comprising:
determining a specified electronic device to be an input signal source of the first display device, and displaying a specified virtual remote controller of the specified electronic device on a second display device of the mobile device;
in response to detecting one or more touch signals on the second display device, determining a virtual remote controller according to the one or more touch signals;
transmitting a first switch signal corresponding to the specified virtual remote controller to the first display device when the determined virtual remote controller is different from the specified virtual remote controller, and controlling the input signal source to switch from the specified electronic device to a default electronic device; and
transmitting a second switch signal corresponding to the determined virtual remote controller to the first display device, and controlling the input signal source to switch from the default electronic device to an electronic device corresponding to the determined virtual remote controller.

2. The method according to claim 1, wherein the determined virtual remote controller is determined by:
determining a selected virtual remote controller displayed on the second display device according to the touch signal;
calculating a display time duration of the selected virtual remote controller that displayed on the second display device; and
determining the selected virtual remote controller to be the determined virtual remote controller, when the display time duration is not less than a predetermined duration.

3. The method according to claim 1, wherein each virtual remote controller corresponds to an identification number, when an identification number of the determined virtual remote controller is different from an identification number of the specified virtual remote controller, the determined virtual remote controller is different from the specified virtual remote controller.

4. The method according to claim 1, wherein the electronic devices are classified into a plurality of signal source groups, each of the plurality of signal source groups has a predetermined electronic device, and each of the plurality of signal source groups corresponds to a group number.

5. The method according to claim 4, further comprising:
storing one or more of the plurality of signal source groups in a storage device of the mobile device; and
predetermining one stored signal source group to be a default signal source group.

6. The method according to claim 5, further comprising:
reading a group number of the default signal source group from the storage device; and
displaying the default signal source group on the second display device.

7. The method according to claim 5, future comprising:
when a signal source group is selected on the second display device, determining a group number of the selected signal source group; and
determining the selected signal source group to be an updated default signal source group.

8. A mobile device, comprising:
a processor; and
a storage device that stores one or more programs, which when executed by the at least one processor, the mobile device being in connection to electronic devices, each of the electronic devices corresponding to a virtual remote controller, causes the at least one processor to:
determining a specified electronic device to be an input signal source of the first display device, and displaying a specified virtual remote controller of the specified electronic device on a second display device of the mobile device;
in response to detecting one or more touch signals on the second display device, determining a virtual remote controller according to the one or more touch signals;
transmitting a first switch signal corresponding to the specified virtual remote controller to the first display device when the determined virtual remote controller is different from the specified virtual remote controller, and controlling the input signal source to switch from the specified electronic device to a default electronic device; and
transmitting a second switch signal corresponding to the determined virtual remote controller to the first display device, and controlling the input signal source to switch from the default electronic device to an electronic device corresponding to the determined virtual remote controller.

9. The mobile device according to claim 8, wherein the determined virtual remote controller is determined by:
determining a selected virtual remote controller displayed on the second display device according to the touch signal;
calculating a display time duration of the selected virtual remote controller that displayed on the second display device; and
determining the selected virtual remote controller to be the determined virtual remote controller, when the display time duration is not less than a predetermined duration.

10. The mobile device according to claim 8, wherein each virtual remote controller corresponds to an identification number, when an identification number of the determined virtual remote controller is different from an identification number of the specified virtual remote controller, the determined virtual remote controller is different from the specified virtual remote controller.

11. The mobile device according to claim 8, wherein the electronic devices are classified into a plurality of signal source groups, each of the plurality of signal source groups has a predetermined electronic device, and each of the plurality of signal source groups corresponds to a group number.

12. The mobile device according to claim 11, wherein the at least one processor further stores one or more of the plurality of signal source groups in a storage device of the mobile device; and
predetermines one stored signal source group to be a default signal source group.

13. The mobile device according to claim 12, wherein the at least one processor further reads a group number of the default signal source group from the storage device; and
displays the default signal source group on the second display device.

14. The mobile device according to claim 12, wherein the at least one processor further:
when a signal source group is selected on the second display device, determine a group number of the selected signal source group; and
determine the selected signal source group to be an updated default signal source group.

15. A non-transitory storage medium having stored thereon instructions that, when executed by a processor of a mobile device, the mobile device being in connection to electronic devices, each of the electronic devices corresponding to a virtual remote controller, wherein the method comprises:
determining a specified electronic device to be an input signal source of the first display device, and displaying a specified virtual remote controller of the specified electronic device on a second display device of the mobile device;
in response to detecting one or more touch signals on the second display device, determining a virtual remote controller according to the one or more touch signals;
transmitting a first switch signal corresponding to the specified virtual remote controller to the first display device when the determined virtual remote controller is different from the specified virtual remote controller, and controlling the input signal source to switch from the specified electronic device to a default electronic device; and
transmitting a second switch signal corresponding to the determined virtual remote controller to the first display device, and controlling the input signal source to switch from the default electronic device to an electronic device corresponding to the determined virtual remote controller.

16. The non-transitory storage medium according to claim 15, wherein wherein the determined virtual remote controller is determined by:
determining a selected virtual remote controller displayed on the second display device according to the touch signal;
calculating a display time duration of the selected virtual remote controller that displayed on the second display device; and
determining the selected virtual remote controller to be the determined virtual remote controller, when the display time duration is not less than a predetermined duration.

17. The non-transitory storage medium according to claim 15, wherein each virtual remote controller corresponds to an identification number, when an identification number of the determined virtual remote controller is different from an identification number of the specified virtual remote controller, the determined virtual remote controller is different from the specified virtual remote controller.

18. The non-transitory storage medium according to claim 15, wherein the electronic devices are classified into a plurality of signal source groups, each of the plurality of signal source groups has a predetermined electronic device, and each of the plurality of signal source groups corresponds to a group number.

19. The non-transitory storage medium according to claim 18, wherein the method further comprises:
storing one or more of the plurality of signal source groups in a storage device of the mobile device; and
predetermining one stored signal source group to be a default signal source group.

20. The non-transitory storage medium according to claim 19, wherein the method further comprises:
reading a group number of the default signal source group from the storage device; and
displaying the default signal source group on the second display device.
